(19) United States
(12) Patent Application Publication
(10) Pub. No.: US 2026/0154799 A1
(43) Pub. Date: Jun. 4, 2026

(54) IMAGE FILTER DETECTION

(71) Applicant: Lenovo Global Technology (United States) Inc., Morrisville, NC (US)

(72) Inventors: Tarah Cook, Raleigh, NC (US); Matthew Dennis Kohut, Cary, NC (US); Mark Christopher Heidenfeldt, Apex, NC (US); Gregory McNeil, Raleigh, NC (US)

(21) Appl. No.: 18/967,156

(22) Filed: Dec. 3, 2024

(51) Int. Cl. G06T 7/00; G06Q 50/00

(52) U.S. Cl. CPC G06T 7/0002; G06Q 10/40; G06T 2207/20081; G06T 2207/20084

(57) ABSTRACT

One embodiment provides a method, the method including: identifying, using a filter detection system, content of an image that is accessible via a digital platform and that is being viewed via a display device; detecting, using an artificial intelligence model of the filter detection system, that a filter has been applied to the image, wherein the artificial intelligence model is configured to analyze the image to detect application of the filter; and transmitting, using the filter detection system and a processor coupled to the display device, a notification indicating that the filter has been applied to the image. Other aspects are claimed and described.

### BACKGROUND

Digital platforms (e.g., social media sites, networking sites, marketing sites, online advertisements, online pages directed towards a specific service, etc.) utilize images, either still images or video images, to convey information to users. Many users utilize digital platforms to encourage followers or viewers of the page of the user to buy or use particular products. For example, influencers use social media sites or pages to tell their viewers or followers about products, services, and/or the like, and the experience of the influencer in relation to the products, services, and/or the like. Many influencers have a large number of viewers or followers and have built trust with the viewers and followers. Thus, with these sites or pages the influencers can influence many people with respect to a particular product, service, and/or the like. This makes the use of influencers to market products, services, and/or the like, attractive to companies and entities that are trying to sell these products, services, and/or the like. The companies and entities simply have to convince the influencer to be willing to market the product, service, and/or the like.

### BRIEF SUMMARY

In summary, one aspect provides a method, the method including: identifying, using a filter detection system, content of an image that is accessible via a digital platform and that is being viewed via a display device; detecting, using an artificial intelligence model of the filter detection system, that a filter has been applied to the image, wherein the artificial intelligence model is configured to analyze the image to detect application of the filter; and transmitting, using the filter detection system and a processor coupled to the display device, a notification indicating that the filter has been applied to the image.

Another aspect provides a system, the system including: a display device; a processor coupled to the display device; a memory device that stores instructions that, when executed by the processor, causes the system to: identify, using a filter detection system, content of an image that is accessible via a digital platform and that is being viewed via a display device; detect, using an artificial intelligence model of the filter detection system, that a filter has been applied to the image, wherein the artificial intelligence model is configured to analyze the image to detect application of the filter; and transmit, using the filter detection system and the processor, a notification indicating that the filter has been applied to the image.

A further aspect provides a product, the product including: a computer-readable storage device that stores executable code that, when executed by a processor, causes the product to: identify, using a filter detection system, content of an image that is accessible via a digital platform and that is being viewed via a display device; detect, using an artificial intelligence model of the filter detection system, that a filter has been applied to the image, wherein the artificial intelligence model is configured to analyze the image to detect application of the filter; and transmit, using the filter detection system and a processor coupled to the display device, a notification indicating that the filter has been applied to the image.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method for detecting when a filter has been applied to content of an image that is accessible via a digital platform and that is being viewed via a display device and notifying a user of the fact that a filter has been applied to an image.

### DETAILED DESCRIPTION

As with many people, influencers can be convinced to market a product, service, and/or the like, in return for a monetary amount. While many influencers would not market a product, service, and/or the like (collectively referred to as “product” for ease of readability), unless they actually believed in the product, not all influencers may be as discerning. Additionally, many people, including people who are displaying images on a digital platform, want to have a product viewed in the best light possible. One problem with digital images is that they can be manipulated. While many of these manipulations are not intended to be deceitful, some of them are, even if the intention is not to be deceitful. For example, a digital image of a sunset that has been manipulated to increase the color saturation results in an image of the sunset that appears to have deeper colors than what would actually be seen if viewing the sunset in person and not through a digital image. The person who manipulated the image may not have intended to deceive viewers, but the viewers were in fact deceived.

When images are manipulated, it can cause viewers to think that the product being featured in the image is better than it might actually be. For example, using the sunset example, viewers may want to visit the location featured in the image so they can see a similar sunset. However, because the image was manipulated, the viewer may never see the same sunset. This is also true of other products that may be featured in images. For example, if an influencer or marketer is trying to sell skin smoothing cream and the image was manipulated to make the influencer's skin look smoother, viewers may think that the cream was effective at smoothing the influencer's skin and may, therefore, be more inclined to buy the product.

Due to the increase in digital images that are utilized, the manipulation of images has become more prevalent and easier. Instead of having to use specialized software that requires a user to learn how to manipulate the images and keep the images appearing natural, software has become more accessible to users and, particularly, those users who want to manipulate images. Now users can utilize software “filters” that automatically manipulate the digital image in a manner associated with the filter. For example, a background removal filter can be utilized to remove and replace the background of an image. As another example, a skin smoothing filter can be applied to smooth the skin of a person included within an image. Instead of having to manipulate different characteristics of the image manually, the user can simply select and apply a filter that results in changes to the image based upon the filter. This makes it much easier and quicker for users to manipulate images, which results in more and more images being manipulated.

A problem with the proliferation of images being manipulated is that viewers can be misled by the images. For example, if an influencer is trying to sell or encourage users to buy a particular product and the image makes it look like the product works or is better than it actually is, the viewers may be inclined to purchase the product. Thus, it would be beneficial to know if an image has been manipulated through the use of one or more filters, either a single filter that performs multiple image manipulations or individual manipulations to the image that cause it to have a different appearance.

One current technique for identifying if a filter has been applied is that filters associated with a particular digital platform cause metadata to be added to the image. Thus, when the image is uploaded or posted to the digital platform, the platform can identify the use of a filter through the metadata. The digital platform may then add a note indicating that a filter has been applied to the image. However, if a filter or manipulations are made to the image not utilizing the digital platform filter, metadata is not added to the image and the digital platform does not identify that a filter has been applied, even if one has been applied.

Another technique is that a user may identify that a filter has been applied to one of their images. However, users may not always want to identify that a filter has been applied. Viewers can also identify that filters have been applied when the filter is very obvious, for example, by making the image look unnatural. However, since not all filters make an image look unnatural, the viewers may not always be able to discern that a filter was applied.

Accordingly, the described system and method provides a technique for detecting when a filter has been applied to content of an image that is accessible via a digital platform and that is being viewed via a display device and notifying a user of the fact that a filter has been applied to an image. The system identifies an image that is being displayed on a digital platform. For example, the system may detect that a viewer is viewing an image on a digital platform, that an image is being uploaded to a digital platform, that a user has selected an image that is displayed on a digital platform, and/or the like. The system analyzes the image using an artificial intelligence model to detect whether a filter has been applied to the image. The artificial intelligence model may be trained utilizing other images of a subject that are known unfiltered images. For example, if the subject of the image is a person, the artificial intelligence model may be trained using images of the person that are known to not be filtered. This training allows the model to identify a change in appearance of the person between an unfiltered image and the displayed image. If a change in appearance has been detected, the system may detect that a filter has been applied, depending on the changes that are detected.

The artificial intelligence model may also, or alternatively, be trained on filters and effects of filters. In other words, the model may be trained on filters and what appearance the filters give an image. Thus, the model can analyze the displayed image to determine if any of the filter effects are detected. Upon detection of the filter effects, the system may determine that a filter has been applied to the image. Upon detection of a filter, the system may notify a viewer that a filter has been applied to the image. The system may not provide a notification of every filter that is applied. Rather, in some cases, the system could identify whether the filter is related to the content or topic of the image. For example, if the image is being used to sell a product, the system may determine whether the filter may influence the sale of the product. If the filter does not influence the sale of the product, then the system may not notify the viewer of the filter. Alternatively, the system may notify the user if the filter would influence the sale of the product.

Therefore, a system provides a technical improvement over traditional methods for filter detection. The described system and method is able to identify when a filter has been applied to an image regardless of when or where the filter was applied. In other words, instead of only being able to identify when filters corresponding to a digital platform are applied, as with traditional techniques, the described system and method is able to identify the application of a filter regardless of whether that filter application occurred using the digital platform filters. Additionally, instead of relying on a user to identify when a filter has been applied, the system is able to identify characteristics of the image or changes in appearance of a subject of the image that are indicative of the application of a filter. Thus, the described system is able to identify the application of filters even when the user posting the image is unwilling or unable to identify that a filter has been applied. Accordingly, the described system and method is able to automatically identify when a filter has been applied and provide such information to a viewer, thereby creating a system for notifying viewers of the application of a filter that is more accurate and more consistent than traditional techniques.

The illustrated example embodiments will be best understood by reference to the figures. The following description is intended only by way of example, and simply illustrates certain example embodiments.

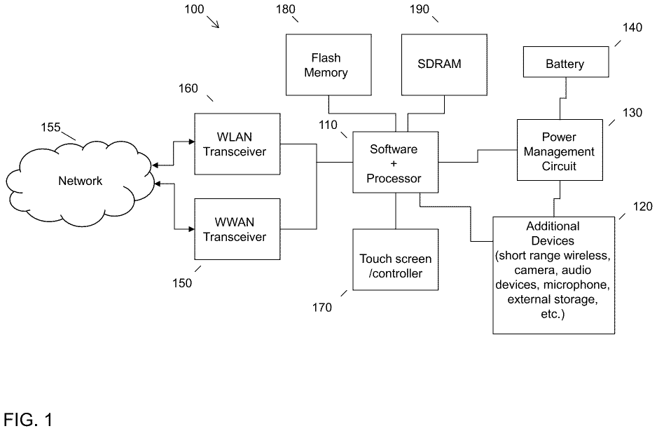

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, input/output (I/O) ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use serial advanced technology attachment (SATA) or peripheral component interconnect (PCI) or low pin count (LPC). Common interfaces, for example, include secure digital input/output (SDIO) and inter-integrated circuit (I2C).

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply basic input/output system (BIOS) like functionality and dynamic random-access memory (DRAM) memory.

System 100 typically includes one or more of a wireless wide area network (WWAN) transceiver 150 and a wireless local area network (WLAN) transceiver 160 for connecting to various networks 155 (e.g., telecommunications networks, wireless Internet devices (e.g., access points), cloud networks, remote networks, local networks, etc.). Additionally, devices 120 are commonly included, e.g., a wireless communication device, external storage, camera, microphone, external storage, etc. System 100 often includes a touch screen 170 for data input and display/rendering. System 100 also typically includes various memory devices, for example flash memory 180 and synchronous dynamic random-access memory (SDRAM) 190.

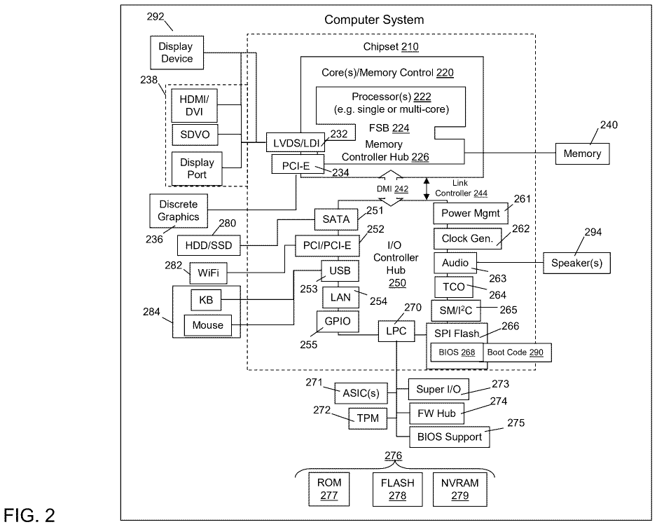

FIG. 2 depicts a block diagram of another example of information handling device circuits, circuitry, or components. The example depicted in FIG. 2 may correspond to computing systems such as personal computers, or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of random-access memory (RAM) that may be referred to as “system memory” or “memory”). The memory controller hub 226 further includes a low voltage differential signaling (LVDS) interface 232 for a display device 292 (for example, a cathode-ray tube (CRT), a flat panel, touch screen, etc.). A block 238 includes some technologies that may be supported via the low-voltage differential signaling (LVDS) interface 232 (for example, serial digital video, high-definition multimedia interface/digital visual interface (HDMI/DVI), display port). The memory controller hub 226 also includes a PCI-express interface (PCI-E) 234 that may support discrete graphics 236.

In FIG. 2, the I/O hub controller 250 includes a SATA interface 251 (for example, for hard-disc drives (HDDs), solid-state drives (SSDs), etc., 280), a PCI-E interface 252 (for example, for wireless connections 282), a universal serial bus (USB) interface 253 (for example, for devices 284 such as a digitizer, keyboard, mice, cameras, phones, microphones, storage, other connected devices, etc.), a network interface 254 (for example, local area network (LAN)), a general purpose I/O (GPIO) interface 255, a LPC interface 270 (for application-specific integrated circuit (ASICs) 271, a trusted platform module (TPM) 272, a super I/O 273, a firmware hub 274, BIOS support 275 as well as various types of memory 276 such as read-only memory (ROM) 277, Flash 278, and non-volatile RAM (NVRAM) 279), a power management interface 261, a clock generator interface 262, an audio interface 263 (for example, for speakers 294), a time controlled operations (TCO) interface 264, a system management bus interface 265, and serial peripheral interface (SPI) Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, personal computer devices generally, and/or electronic devices, which may be used to view digital images on a digital platform, upload digital images to a digital platform, identify that an image that is being displayed on a digital platform has had a filtered applied, and/or the like. For example, the circuitry outlined in FIG. 1 may be implemented in a tablet or smart phone embodiment, whereas the circuitry outlined in FIG. 2 may be implemented in a personal computer embodiment.

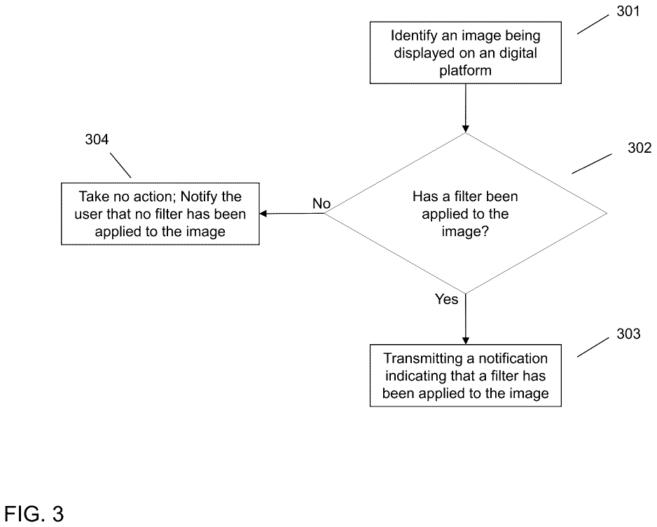

FIG. 3 illustrates an example method for detecting when a filter has been applied to content of an image that is accessible via a digital platform and that is being viewed via a display device and notifying a user of the fact that a filter has been applied to an image. The method may be implemented on a system which includes a processor, memory device, output devices (e.g., display device, printer, etc.), input devices (e.g., keyboard, touch screen, mouse, microphones, sensors, biometric scanners, etc.), image capture devices, and/or other components, for example, those discussed in connection with FIG. 1 and/or FIG. 2. While the system may include known hardware and software components and/or hardware and software components developed in the future, the system itself is specifically programmed to perform the functions as described herein to detect when a filter has been applied to an image and notify a user of such. Additionally, the filter detection system includes modules and features that are unique to the described system.

Accordingly, the filter detection system may be activated in order to detect whether a filter has been applied to content of an image that is accessible via a digital platform and that is being viewed via a display device. The image may be either a still image or a video image. For example, a user may have displayed a still image or may have created a video that has been posted to a digital platform. The filter may be a predefined filter which performs multiple manipulations on an image. The filter may also be any manipulation performed by a user that changes the content of the image. In other words, the filter could be a predefined filter or other manipulation that modifies the content of the image to make the appearance of the content within the image look different than the real-world scene represented by the image.

Activation of the filter detection system may be a manual activation of the filter detection system and/or an automatic activation of the filter detection system. Manual activation of the system may include a user opening an application associated with the filter detection system, the user accessing the computing system associated with the filter detection system, and/or the user otherwise providing input to the filter detection system. The automatic activation of the filter detection system may be based upon the detection of a trigger event indicating that the system should be activated. Example trigger events include a user accessing a digital platform having displayed images, a user providing input to an image indicating the system should perform the filter detection, detection of a user viewing images, activation of software or an application utilizing the filter detection system, and/or the like.

The filter detection system may be made of multiple systems or modules that communicate together to make up the filter detection system or may be a single system. The filter detection system may be a standalone system, may be accessible through other computing devices, and/or a combination thereof. For example, the filter detection system may be a standalone system that can be accessed by a user and/or may be or provide an application that is accessible by a user on another computing device. The filter detection system may be accessible using any type of computing device, for example, personal computer, laptop computer, smartphone, tablet, smartwatch, head-mounted display, smart television or other smart appliance, augmented reality device, virtual reality device, and/or the like. Thus, the filter detection system may be accessible locally using a computing device where the filter detection system is installed and/or may be accessible remotely through another computing device. For example, the filter detection system may be accessed by a user using a device that communicates with the filter detection system to detect filters applied to an image displayed on a digital platform, access profiles for the filter detection system, and/or the like. However, the filter detection system may be located and operate on a different information handling device to perform the described steps.

The detection of whether filters have been applied to content of an image that is accessible via a digital platform and that is being viewed via a display device can be provided as a service to other entities or companies. In other words, the filter detection system could be stored on a server or network of a company and the system could perform the detection of filters for other companies or entities, with the other companies or entities paying for the detection of filters or use of the filter detection system. For example, a digital platform may utilize the service to detect any filters that have been applied to images being displayed on the digital platform so the digital platform can notify users of the application of filters.

The filter detection system may have an associated graphical user interface. The graphical user interface may be provided on a display or monitor, which may or may not be associated with the filter detection system. In other words, the filter detection system may have a dedicated display or monitor or may be accessible using any display or monitor. In either case, the filter detection system may provide instructions to generate and display the graphical user interface on the display device being used to access the filter detection system. The graphical user interface may also be updated and managed based upon instructions provided by the filter detection system. In other words, the filter detection system generates and transmits instructions to create and update the graphical user interface.

The graphical user interface may include a plurality of tabs, windows, and/or unique interfaces. The graphical user interface may include graphical user interface icons or elements. Graphical user interface icons or elements may include static non-selectable elements (e.g., headers, footers, logos, global information areas, graphics, etc.), dynamic non-selectable elements (e.g., local information areas applying to a specific element, dynamic graphics, information areas that update based upon the information provided therein, indicators, statistics displays, etc.), static selectable elements (e.g., radio buttons, menu icons, selectable indicators, etc.), dynamic selectable elements (e.g., form field input areas, pull-down menus, pop-up windows, etc.), and/or any other elements that may be found in a graphical user interface.

The graphical user interface may allow a user to provide input identifying information to be used by the filter detection system. For example, the filter detection system may utilize a user profile, digital platform profile, historical information, and/or the like, to identify when the system should determine whether a filter has been applied to content of an image that is accessible via a digital platform and that is being viewed via a display device, when the filter detection system analyze an image to detect a filter, what digital platforms for which filters should be detected, and/or the like. The graphical user interface may allow for creation of or access to these profiles, historical information, and/or the like, by allowing a user to input information regarding user preferences, digital platform preferences, and/or the like. As will be discussed in more detail, the use of user provided information is not the only way that the profile and/or historical information can be created. The filter detection system can then utilize these inputs to create the profile(s), store the historical information, and/or the like.

A user could also use the graphical user interface to adjust information within the profile(s), historical information, and/or the like. Additionally, or alternatively, the user can input a location of information related to one or more of the profiles, historical information, and/or the like, provide a file corresponding to information related to the information, and/or the like, within the graphical user interface. Input may be provided by the user using any type of input modality, including, but not limited to, mechanical input (e.g., keyboard input, mouse input, etc.), touch input, audible or voice input, gesture input, haptic input, thought input, and/or the like.

The graphical user interface may also provide displays that display information of the profiles, detected filters, digital platforms and preferences, and/or the like. It should be noted that the information to be used by the filter detection system and information provided by the filter detection system can be different for different applications, different computing systems, different users, and/or the like. Thus, the information corresponding to input or output of the filter detection system are not always the same. However, the filter detection system may have default or system-wide settings that are the same across different users, systems, applications, and/or the like, until the information is adjusted or otherwise changed.

It should be noted that different users may configure the graphical user interface per their preferences. Thus, the graphical user interface layout and configuration may be different between users. How much a user can configure the layout may be restricted or set by a system administrator and/or the like. Additionally, different users or different user roles may have different levels of access, which may also change how and what information is displayed. Thus, different graphical user interfaces may be displayed by the system.

The filter detection system may utilize one or more artificial intelligence models in detecting whether a filter has been applied to an image. Artificial intelligence models could be used to detect the application of a filter on an image, determine when to determine if a filter has been applied, determine how to notify a user of a detected filter, and/or any other steps within the described system. Artificial intelligence models may also be used for steps within a step. For example, a model could be utilized to perform image analysis to identify whether a filter has been applied, to perform image analysis to determine the type of filter that has been applied, and/or the like. For ease of readability, the majority of the description will refer to a single artificial intelligence model. However, it should be noted that an ensemble of artificial intelligence models or multiple artificial intelligence models may be utilized. Additionally, the term artificial intelligence model within this application encompasses neural networks, machine-learning models, deep learning models, artificial intelligence models or systems, and/or any other type of computer learning algorithm or artificial intelligence model that may be currently utilized or created in the future.

The artificial intelligence model may be a pre-trained model that is fine-tuned for the filter detection system or may be a model that is created from scratch. Since the filter detection system is used in conjunction with detecting whether a filter has been applied to an image, some models that may be utilized by the system are image analysis models, image effect analysis models, other analysis models, similarity identification models, comparison models, language models, large language models, filtering models, classification models, and/or the like. The model may be trained using one or more training datasets. Additionally, as the model is deployed, it may receive feedback to become more accurate over time. Alternatively, or additionally, the model may utilize inputs provided to the model to continually learn, thereby using the inputs to make subsequent predictions or using the inputs within the subsequent predictions. The feedback or inputs may be automatically ingested by the model as it is deployed. For example, as the model is used to perform the described method, if a user modifies predictions that were made by the model, provides feedback regarding a prediction, or otherwise provides some indication that the predictions or selections made by the model may be incorrect, the model may ingest this feedback to refine the model.

On the other hand, as the model makes predictions in connection with performing the described steps, and no changes are made to the resulting prediction, the model may utilize this as feedback to further refine the model. This may be referred to as reinforcement training where a prediction that was made by the model is reinforced as the correct prediction. Training the model may be performed in one of any number of ways including, but not limited to, supervised learning, unsupervised learning, semi-supervised learning, training/validation/testing learning, and/or the like.

The feedback or inputs could be stored within a data store and utilized at a later time to train or retrain the model. For example, a user could use the feedback to update a training dataset to train or retrain the model. The feedback or inputs could also be stored within the data store and then be used by the model for updated training. This may be done, for example, in an unsupervised learning session that allows the model to learn patterns and information regarding the training dataset without the need for human supervision, thereby providing at least a partially automated technique for the model to become updated. However, the model may or may not perform this retraining without a human providing input to the model to perform the retraining. In other words, retraining of the model may be based upon how the model is programmed and whether the model is updated while it is deployed or is only updated during a training mode may be based upon that programming.

As previously mentioned, an ensemble of models or multiple models may also be utilized. Some example models that may be utilized are variational autoencoders, generative adversarial networks, recurrent neural network, convolutional neural network, deep neural network, autoencoders, random forest, decision tree, gradient boosting machine, extreme gradient boosting, multimodal machine learning, unsupervised learning models, deep learning models, transformer models, inference models, and/or the like, including models that may be developed in the future. The chosen model structure may be dependent on the particular task that will be performed with that model.

The filter detection system may include different components for carrying out different functions of the system, including different steps to be performed. These components may be hardware components or software components. Some hardware devices or components that may be utilized by the filter detection system include input devices that may be utilized to receive input from the user, for example, mechanical input modalities (e.g., keyboard, mouse, etc.), touch input devices, gesture input devices, electromyography input devices, audio input devices, and/or the like. Other hardware components may be utilized to provide output from the filter detection system. For example, the filter detection system may include speakers, displays or monitors, haptic output devices, audio output devices, and/or the like. Other hardware components may be included to capture images, for example, an image capture device, screen capture devices, and/or the like. Other hardware components may include data storage devices, including on devices of the user (e.g., mobile device, personal computer, laptop, tablet, smart watch, etc.), devices or components of the filter detection system, and/or the like.

Some software components include the user profile that stores information related to the user and user preferences. Within the user profile the user can identify information related to when the user might want the system to detect whether an image has had a filter applied. For example, the user may provide input to the user profile that indicates the system should be deployed to detect filters when certain digital platforms are accessed. The user profile may also identify the types of filters that the user wants the system to detect, certain topics of an image for which filters should be detected, certain subjects or subject types within an image for which filters should be detected, the types of notifications that should be provided, whether the system provides additional information with a notification, and/or the like. Similarly, digital platform profiles can be generated for digital platforms to identify when filters should be detected, what steps should be taken when a filter has been detected, how notifications should be provided to viewers, and/or the like.

Profiles can be populated with information manually by the corresponding entity of the profile or can be populated over time as the system learns more about the entity. For example, a user may manually provide input to a user profile and the system can learn preferences about the user over time and populate the user profile with this learned information. Learned information may be information learned based upon direct inputs, for example, a user may be presented with a pop-up window in response to a trigger and provide input to the pop-up window. This input can be then populated into the user profile. Learned information may also be information learned based upon indirect inputs, for example, a user may view images displayed on a digital platform and may provide inputs (e.g., audible inputs, visual inputs, gesture inputs, etc.) that indicate that the user is interested in knowing whether a filter was applied to an image. The system can then aggregate this information to learn that the user prefers to know whether filters have been applied to images of certain products, of certain subjects, related to certain topics, and/or the like.

At 301, the filter detection system may identify an image that is being displayed on a digital platform. A digital platform may be any type of website, application, program, and/or the like, where images can be digitally displayed. Thus, a digital platform may be an entire website that is dedicated to the provision of images by many different people and that can be viewed by many different people. A digital platform may also be a single website that is dedicated to a single entity, for example, a webpage for a business, a webpage for a destination, a webpage for person, and/or the like. Thus, the term digital platform encompasses any digital location that can be accessed by a viewer, including those accessed via the Internet, through a remote network location, through a local network connection, and/or the like. While a social media platform will be the example used throughout this disclosure, it should be noted that this is not intended to be limiting as any type of digital platform can be utilized.

An image may be a still image, a video image, and/or the like, or a combination thereof. Thus, the system can detect any type of image that is being displayed and that is viewable to a viewer. Identification of the image being displayed may be responsive to receiving a trigger event or some indication that the image should be analyzed. To analyze all possible images may be very resource intensive. Thus, the system may reduce the use of resources by not analyzing all images. However, all images could be analyzed if desired. The indication may include an indication provided by a user, may be an indication provided within the user profile, may be an indication provided by a digital platform, and/or the like. Thus, possible indications may include detecting that a viewer is viewing an image (e.g., gaze tracking detects the user gaze on an image, the image is displayed for a predetermined threshold period of time, the user provides an input (e.g., audible, visual, gesture-based, etc.) indicating the user is viewing the image, etc.), that an image is being uploaded or posted to a digital platform, that a user has selected an image that is being displayed on a digital platform, and/or the like.

In addition to identifying an image that is being displayed on a digital platform, the system may identify other information corresponding to the image. The system may utilize image analysis techniques, image parsing techniques, entity identification techniques, artificial intelligence model techniques, color analysis techniques, and/or the like, or a combination thereof, to perform the identification of information within the image. Some information that the system may identify is content within the image. Content within the image may include subjects or entities within the image (e.g., products, people, landscapes, landmarks, etc.), portions of the image (e.g., background, foreground, etc.), and/or the like. Identification of the content may include a specific identification where the system identifies a name or identifier of the subjects or entities, portions of the image, and/or the like.

Additionally, or alternatively, identification of the content may include a general identification where the system identifies a type of the subjects or entities, portions of the image, and/or the like. For example, specifically identifying a person within an image would include identifying the exact person, whereas a general identification would be simply identifying the subject a person. The system could also identify other information related to the content, for example, characteristics of the content (e.g., color, texture, shapes, characteristics of a subject or entity, etc.), a location of pieces of content with respect other pieces of content, a frequency that certain content appears within an image, and/or any other information that provides a context of the content.

Other information that the system may identify with respect to the image is a topic of the image. In addition to the image information of the image, the system can utilize other information that corresponds to the image, for example, any audible content that corresponds to the image, any tags or metadata associated with the image, any text associated with the image, and/or the like. To identify this information, the system may utilize one or more appropriate analysis techniques, for example, audio analysis techniques, text parsing techniques, entity identification techniques, semantic analysis, syntactic analysis, artificial intelligence models, and/or the like, or a combination thereof. From the information identified from the image itself and any other corresponding information, the system may identify a topic of the image. Topic analysis techniques along with the other analysis techniques can be used by the system to determine a topic of an image.

The topic may identify the purpose of the image and what is the main focus, or subject, of the image. The purpose of the image may identify why the image is being displayed and what the intent is of the user who has posted the image. For example, a purpose may be to encourage viewers to use or not use a particular service or product, to visit a particular location, discourage or encourage a particular behavior, to provide information, and/or the like. Images may also have more than one purpose, which could be identified. The main focus, or subject, of the image is what product, service, object, and/or the like, the image is directed towards or is focused upon. Thus, the main focus may be a person, a product, a service, a location, a behavior, and/or the like. As an example, in a video image of an influencer trying to sell a particular beauty product, the purpose would be to sell the product and the main focus is the particular beauty product. As another example, in a still image of a sunset at a particular location, the purpose may be to encourage people to visit the location and the main focus is the views at the particular location.

At 302, the system determines if the system can detect whether a filter has been applied to the image. For ease of readability the term “filter” will be used to refer to any digital manipulation of an image. While some manipulations may be performed using a provided or predefined filter that makes specific changes to the image, for example, augmented reality filters, color adjusting filters, retouch filters, beauty filters, and/or the like, other manipulations may be made by a user without the use of a particular filter, for example, color contrast adjustments, color saturation adjustments, color hue adjustments, and/or the like. In other words, digital platform filters may automatically make multiple adjustments to an image to give it a specific appearance. The term “filter” includes such filters and also includes adjustments made to the content of the digital image that are not the application of a predefined filter, but that result in similar changes to the digital image as the predefined filters. Additionally, the system may determine that more than one filter has been applied to an image. In other words, detecting a filter may include detecting that more than one filter has been applied to an image. For ease of readability, a single filter will be discussed here throughout. However, this is not intended to limit the scope of this disclosure to detecting only a single filter.

To detect whether a filter has been applied to the image, the system may utilize at least an artificial intelligence model of the filter detection system. The artificial intelligence model may analyze the image to detect whether a filter has been applied to the image. In other words, the model may analyze the image to detect the application of a filter. The analysis performed by the artificial intelligence model may include visually analyzing the image. Additionally, the artificial intelligence model may analyze at least one non-visible portion of an image file including the content. Other detection techniques may also be used to detect whether a filter has been applied. For example, the system may utilize a rules engine that takes as input the information identified from the image and any other corresponding information to provide an output related to a likeliness of the application of a filter having been applied to the image. As another example, the system may utilize traditional filter detection techniques to detect whether a filter has been applied, such as identifying that a tag or metadata has been added to the image that indicates that a filter was applied, relying on human input indicating a filter has been applied, and/or the like.

As a final, non-limiting example, the system may utilize secondary sources to perform comparisons between the image and other known unfiltered images. For example, the system could access a secondary source (e.g., datastore of unfiltered images, Internet sources, etc.) and compare at least a portion of the image (e.g., the subject or main focus of the image, a product within the image, etc.) to the images within the secondary source to determine if there appears to be a difference between the image, or portion of the image, and the unfiltered images that would be indicative of the application of a filter to the image. It should be noted that these detection techniques are merely illustrative and are not intended to be limiting. Other detection techniques are contemplated and possible.

In addition to using these detection techniques to determine whether a filter was applied to the image, these detection techniques can be used to increase a confidence level of an output of the artificial intelligence model. For example, if a confidence level of an output of the model is below a predetermined threshold, another detection technique may be utilized to increase the confidence level of the output. Alternatively, the system may only rely on the output from the model in detecting whether a filter was applied to the image.

As part of the analysis, the system and/or model may utilize some of the information that was identified when identifying the image. For example, the system may utilize the identification of the content, identification of portions of the image, and/or the like, to assist in determining if a filter was applied. The system may also identify more granular information about the image that would assist in identifying if a filter was applied. More granular information may include a texture of portions of the image (e.g., blurred, sharp, digitally rendered texture, etc.), color characteristics (e.g., saturated, different contrasts, individual color hues, etc.), a location of lines or edges within the image (particularly with respect to other lines or edges within the image), lighting characteristics, and/or the like. The analysis of the information in addition to what is found directly within the image may be useful when utilizing an artificial intelligence model that is trained on filters and filter effects.

An artificial intelligence model that is trained on filters and filter effects may be provided with a training dataset that have images where filters have been applied. The training dataset may be a supervised training dataset that is annotated by humans to identify the filter or filter type that was applied or the manipulations that were made to the image from the use of the filter. The training dataset may also be an unsupervised or semi-supervised training dataset that includes images having filters and images without filters, where the dataset may be grouped based upon filtered and unfiltered images, images having a particular type of filter applied, filtered images and a corresponding unfiltered image, and/or the like. The groupings and labels may vary based upon the type of training dataset and training mode that is utilized for training the model.

The model can then identify the effects on the image and changes to characteristics of the image that are caused by a particular filter. As an example, one filter may soften the clarity of portions of the image, which would have a smoothing effect on areas of the image. As another example, another filter may increase the contrast of an image and also change a saturation of certain hues of image, which may cause colors of the image to be more dramatic. As a final, non-limiting example, a filter may add graphics to portions of the image. As can readily be understood, these are merely illustrative types of filters and the number and types of filters is vast, as are the effects of filters. Thus, the model is able to utilize the training dataset to identify effects of the filters on an image to then detect these effects within an image.

Accordingly, the trained model can analyze the image and the information corresponding to the image to determine if any of these effects are detected within the image. Detection of these effects may then be indicative of the application of a filter. In other words, the model can analyze characteristics of the image (e.g., clarity, color cues, saturation, contrast, object edges, placement of objects with respect to other objects, graphics, focal length, background, foreground, object size, proportions of parts of objects with respect to other parts of objects, etc.) and identify that the characteristics of the image match at least one filter effect.

The artificial intelligence model, which may be a different model than that described above, can also be trained on images of a subject that may be included in an image. For example, the model could be trained on images of popular influencers, products that are the subject of many different images, images of users within images, and/or the like. The training dataset could include images of the subject that are unfiltered images. The training dataset could be any type of training dataset as described above, for example, a supervised training dataset, an unsupervised training dataset, a semi-supervised training dataset, and/or the like, or a combination thereof. Thus, the description provided in connection with the model trained on filters and filter effects is applicable here, except that this model is trained on images of a subject that include unfiltered images of the subject.

This trained model can analyze the image in view of the unfiltered image training to determine if there is a change in appearance of the subject between the image and the unfiltered images. Since a subject may change appearances without the use of a filter, the model may then analyze any detected changes in the appearance of the subject to determine if the changes are indicative of the application of a filter to the image. For example, a change in a color of clothing of a subject between the image and the unfiltered images may not be indicative of a filter, whereas a change in a richness of color may be indicative of a filter. Thus, not only does this model identify if there is a change in the appearance of the subject, but also determines if the change in appearance is indicative of the use of a filter on the image. It should be noted that while the training of the artificial intelligence model has been discussed with respect to specific datasets, the artificial intelligence model could be trained on different datasets. For example, a single model or ensemble of models could be trained on both filters and filter effects and images of a subject. Other training datasets are contemplated and possible, for example, image metadata, digital platform information, and/or the like.

In addition to detecting that a filter has been applied, the system can also determine the specific filter that has been applied or a type of filter that has been applied. By identifying the effects within the image that have been caused by the application of a filter, the system may be able to identify the filter or type of filter that has been applied. The system can utilize the effects to identify those filters that cause such effects, thereby allowing the system to identify the filter or filter type. An artificial intelligence model, a rules engine, similarity or comparison techniques, and/or the like, or a combination thereof, may be used to identify the filter or type of filter that has been applied.

Since different digital platforms may have different filters or filters named different things as compared to filters for other digital platforms, the system may identify the type or category of filter instead of the specific filter that has been applied. Thus, filters may be grouped by filter effects and the system may identify the type or category of the filter. To group the filters, the system may identify the effects of filters and then group those filters having the same or similar filter effects into the same group or category. The system may then label a category based upon the filter effect or a purpose of a filter. For example, filters that perform a skin smoothing function may all be grouped into a category with a skin smoothing category label. As another example, filters that create more vivid colors may be all grouped into a category with a color saturation category label. Some filters may have multiple purposes or multiple effects. Such filters may either be grouped into multiple categories or may be grouped into a different category.

If the system determines that a filter has not been applied to the image at 302, the system may take no action and/or notify the user that no filter has been applied to the image at 304. The system may identify that no filter has been applied to the image if the system is not able to identify any filter effects within the image or that the image appears to be an unfiltered image. However, the system may also identify that a filter has been applied to the image, but that the filter does not have an effect on the purpose of the image or on the main focus of the image. In other words, the system may determine that a filter has been applied, but the detected filter is not related to the topic of the image. The system may also identify that a filter has been detected, but the detected filter does not materially change the content of the image. Thus, the system may determine that a relevant filter has not been applied to the image and may take no action and/or notify the user that no relevant filter has been detected.

Alternatively, the system may notify the user that a filter has been applied regardless of whether the filter is relevant to the topic of the image or regardless of whether the filter appears to change the content of the image. Whether the system notifies the user of the application of a filter to the image whenever a filter is detected or only if the filter is relevant may be identified within the user profile, may be default settings, may be based upon a digital platform profile, and/or the like.

If the system determines that a filter has been applied to the image at 302, the system may notify a user viewing the image that a filter has been applied to the image at 303. Notifying the user may be responsive to determining that a relevant filter has been applied to the image, for example, by identifying that the filter is related to the topic of the image, identifying that the filter materially alters the content of the image, identifying that the filter may change a perception of the viewer regarding the image, and/or the like. Providing a notification may be performed using any technique for providing notifications, for example, providing a pop-up window, adding a note to the image, changing a feature of the image (e.g., adding text to the image, changing a border color of the image, changing an animation of the image, etc.), adding a tag to the image, and/or the like. The notification may also be provided when the user provides input to the image, for example, by selecting the image, providing input (e.g., visual input, audible input, gesture input, etc.) indicating the notification should be provided, hovering over the image, and/or the like.

When providing the notification, the system may also provide additional information. The system may provide any information that has been determined about the filter, for example, the type of the filter, the category of the filter, the name of the filter, the effects caused by the filter, the portions of the image affected by the filter, and/or the like. The system may also provide other information that may assist the user. For example, the system may provide an unfiltered image of the subject of the image. If the system has access to unfiltered images, the system could provide the unfiltered image of the subject of the image so that the viewer can see what the subject looks like without the filter. To provide the unfiltered image, the system could access a secondary source, could access the training dataset that includes unfiltered images, and/or the like, to obtain the unfiltered image. The unfiltered image, or an approximation of an unfiltered image, could be provided within the notification. The filter detection system could generate an opposing or countering filter that is configured to remove the effects of the originally applied filter, which would result in an unfiltered image, or an approximation of an unfiltered image. This “unfiltered” image could then be provided within the notification.

As an overall non-limiting example of the described system, a viewer may be viewing image on a social media website where an influencer has posted a video to encourage viewers to visit a restaurant based upon the generous portions that are provided. The system analyzes the image and determines that two filters have been applied to the image. One filter changes the background of the image to make it less distracting in the image. The other filter changes the size of the food to make it appear larger. On one hand, the system may notify the user of the use of both of these filters and may indicate the effect of the filters. Alternatively, the system may determine that the filter used to change the background is not a relevant filter and may not notify the viewer of this filter. However, the system may determine that the second filter which changed the size of the food is relevant because it relevant to the topic of the image. Accordingly, the system may notify the viewer of the use of this filter. The system may also attempt to determine if unfiltered images of the food can be accessed and may, if accessible, provide these unfiltered images of the food to the viewer.

It will be readily understood that the components of the embodiments, as generally described and illustrated in the figures herein, may be arranged and designed in a wide variety of different configurations in addition to the described example embodiments. Thus, the more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

As will be appreciated by one skilled in the art, various aspects may be embodied as a system, method, or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Additionally, the term “non-transitory” includes all media except signal media.

Program code embodied on a storage medium may be transmitted using any appropriate medium, including but not limited to wireless, wireline, optical fiber cable, radio frequency, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices, and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, the method comprising:
identifying, using a filter detection system, content of an image that is accessible via a digital platform and that is being viewed via a display device;
detecting, using an artificial intelligence model of the filter detection system, that a filter has been applied to the image, wherein the artificial intelligence model is configured to analyze the image to detect application of the filter; and
transmitting, using the filter detection system and a processor coupled to the display device, a notification indicating that the filter has been applied to the image.

2. The method of claim 1, wherein the identifying comprises identifying a topic of the image;
wherein the detecting that a filter has been applied comprises detecting that the filter is related to the topic; and
wherein the notifying is responsive to the detecting that the filter is related to the topic.

3. The method of claim 1, wherein the artificial intelligence model is trained on at least filters and effects of filters and wherein the detecting comprises the artificial intelligence model identifying characteristics of the image that match at least one filter effect.

4. The method of claim 1, wherein the artificial intelligence model is trained on at least images of a subject of the image and wherein the detecting comprises the artificial intelligence model identifying a change in appearance between the subject within the image and the subject in unfiltered images.

5. The method of claim 4, wherein the detecting comprises determining the change in appearance is indicative of a filter.

6. The method of claim 1, wherein the transmitting of the notification comprises retrieving and transmitting an unfiltered image of the subject.

7. The method of claim 1, wherein the detecting comprises identifying a type of the filter and wherein the notifying comprises indicating the type of the filter.

8. The method of claim 1, wherein the detecting comprises detecting more than one filter has been applied.

9. The method of claim 1, wherein the detecting comprises utilizing a technique in addition to the artificial intelligence model, wherein the technique comprises comparing at least a portion of the image to images within a secondary source and identifying a difference between the at least a portion of the image and the images within the secondary source, wherein the difference is indicative of the application of the filter.

10. The method of claim 1, wherein the image is selected from the group consisting of: a still image and a video image.

11. A system, the system comprising:
a display device;
a processor coupled to the display device;
a memory device that stores instructions that, when executed by the processor, causes the system to:
identify, using a filter detection system, content of an image that is accessible via a digital platform and that is being viewed via a display device;
detect, using an artificial intelligence model of the filter detection system, that a filter has been applied to the image, wherein the artificial intelligence model is configured to analyze the image to detect application of the filter; and
transmit, using the filter detection system and the processor, a notification indicating that the filter has been applied to the image.

12. The system of claim 11, wherein the identifying comprises identifying a topic of the image;
wherein the detecting that a filter has been applied comprises detecting that the filter is related to the topic; and
wherein the notifying is responsive to the detecting that the filter is related to the topic.

13. The system of claim 11, wherein the artificial intelligence model is trained on at least filters and effects of filters and wherein the detecting comprises the artificial intelligence model identifying characteristics of the image that match at least one filter effect.

14. The system of claim 11, wherein the artificial intelligence model is trained on at least images of a subject of the image and wherein the detecting comprises the artificial intelligence model identifying a change in appearance between the subject within the image and the subject in unfiltered images.

15. The system of claim 14, wherein the detecting comprises determining the change in appearance is indicative of a filter.

16. The system of claim 11, wherein the transmitting of the notification comprises retrieving and transmitting an unfiltered image of the subject.

17. The system of claim 11, wherein the detecting comprises identifying a type of the filter and wherein the notifying comprises indicating the type of the filter.

18. The system of claim 11, wherein the detecting comprises detecting more than one filter has been applied.

19. The system of claim 11, wherein the detecting comprises utilizing a technique in addition to the artificial intelligence model, wherein the technique comprises comparing at least a portion of the image to images within a secondary source and identifying a difference between the at least a portion of the image and the images within the secondary source, wherein the difference is indicative of the application of the filter.

20. A product, the product comprising:
a computer-readable storage device that stores executable code that, when executed by a processor, causes the product to:
identify, using a filter detection system, content of an image that is accessible via a digital platform and that is being viewed via a display device;
detect, using an artificial intelligence model of the filter detection system, that a filter has been applied to the image, wherein the artificial intelligence model is configured to analyze the image to detect application of the filter; and
transmit, using the filter detection system and a processor coupled to the display device, a notification indicating that the filter has been applied to the image.
